(19) United States
(12) Patent Application Publication
(10) Pub. No.: US 2024/0102205 A1
(43) Pub. Date: Mar. 28, 2024

(54) MULTIFUNCTIONAL FIBER WITH FULL-SPECTRUM INFRARED RADIATION, FLAME RETARDANT AND ANTIBACTERIAL FUNCTIONS AND PREPARATION METHOD THEREOF

(71) Applicant: Zhejiang Tongkun New Materials Research Institute Co., Ltd., Jiaxing, Zhejiang (CN)

(72) Inventors: Shengjun LI, Tongxiang, Zhejiang (CN); Shouyun ZHANG, Jiaxing, Zhejiang (CN); Yanlin SUN, Tongxiang, Zhejiang (CN); Yanli LIU, Jiaxing, Zhejiang (CN); Tingting QIAN, Jiaxing, Zhejiang (CN); Mengna LOU, Jiaxing, Zhejiang (CN); Weixing YANG, Tongxiang, Zhejiang (CN)

(21) Appl. No.: 17/920,393

(22) PCT Filed: Dec. 8, 2021
(86) PCT No.: PCT/CN2021/136222

§ 371 Date: Nov. 17, 2023

(30) Foreign Application Priority Data
Feb. 23, 2021 (CN) 202110204345.9

(51) Int. Cl. D01F 1/10; C08J 3/22; C08K 13/06; C08L 67/02; C08L 77/02; D01D 1/04; D01D 5/08; D01F 6/60; D01F 6/62; D02G 1/02

(52) U.S. Cl. CPC D01F 1/10; C08J 3/226; C08K 13/06; C08L 67/02; C08L 77/02; D01D 1/04; D01D 5/08; D01F 6/60; D01F 6/62; D02G 1/0206; C08K 2003/2255; C08L 2201/02; C08L 2310/00; D10B 2331/02; D10B 2331/04; D10B 2401/04; D10B 2401/13

(57) ABSTRACT

A multifunctional fiber with full-spectrum infrared radiation, flame retardant and antibacterial functions, including a composite masterbatch having a water content of 30-50 ppm and accounting for 10-12% by weight, polyethylene terephthalate having a water content of 25-30 ppm or polycaprolactam high polymer having a water content of 50-70 ppm and accounting for 88-90% by weight; the fiber and its fabric possess multiple functions such as spectral heating, flame retardancy, anti-bacteria and anti-virus; after being illuminated for 5-10 minutes, the temperature difference of the fiber fabric of the present invention is higher than 15-20° C., the far-infrared emissivity is greater than 98%, the radiation temperature rise is greater than 3.0° C., the CLO value is greater than 0.5, the heat transfer coefficient is greater than 18.0w/(m²k), and the thermal resistance is less than 0.05 (m²k)/w. The antibacterial rate against Escherichia coli, Staphylococcus aureus, Candida albicans and pneumobacillus is greater than 99.0%.

### TECHNICAL FIELD

This invention generally relates to the technical field of textiles, and more particularly, to a multifunctional fiber with full-spectrum infrared radiation, flame retardant and antibacterial functions and a preparation method thereof.

### BACKGROUND

Polyester and nylon are the most extensively used raw materials for clothing fabrics. Due to the ideal strength and washing-friendly nature of the fabrics, they are widely applied in commercial fields such as textiles and garments. However, in special fields such as military projects and protective clothing, their applications are very limited. To meet the demands of those fields, their performances need to be greatly improved. The singular function of their products has severely restricted the development of this industry. Moreover, because various modifiers are added and used simultaneously, the materials are easy to affect each other, agglomerate or react, failing to exert comprehensive functions. Meanwhile, for conventional methods, due to the adding of various modifiers and the large amount used, spinning becomes difficult and the filaments are easy to float and break, resulting in the failure of fiber formation.

To solve the aforesaid technical problems, the present invention provides a multifunctional fiber with full-spectrum infrared radiation, flame retardant and antibacterial functions and a preparation method thereof.

### SUMMARY OF INVENTION

### Technical Problems

### Solution of Technical Problems

### Technical Solution

The purpose of the present invention is to provide a multifunctional fiber with full-spectrum infrared radiation, flame retardant and antibacterial functions and a preparation method thereof. Through adopting the present invention, a multifunctional fiber with properties of photoheating, infrared warmth preservation, flame retardancy and anti-bacteria is prepared.

To achieve the above objective, the present invention adopts the following technical solution: a multifunctional fiber with full-spectrum infrared radiation, flame retardant and antibacterial functions, comprising: a composite masterbatch having a water content of 30-50 ppm and accounting for 10-12% by weight, polyethylene terephthalate having a water content of 25-30 ppm or polycaprolactam high polymer having a water content of 50-70 ppm and accounting for 88-90% by weight.

In another preferred embodiment, the composite masterbatch further comprising: polybutylene terephthalate having a water content of 23-27 ppm and accounting for 40-50% by weight, nano molybdenum oxide accounting for 6.7-10.0% by weight, nano zinc oxide accounting for 3.3-5.0% by weight, nano cuprous oxide accounting for 3.3-5.0% by weight, and melamine phosphate having a water content of 25-30 ppm and accounting for 6.7-10.0% by weight.

It is worth mentioning that, in the present invention, the nano molybdenum dioxide is a spectral heating agent and a far-infrared emitter, the nano zinc oxide and nano cuprous oxide are antibacterial and antiviral agents, and the melamine phosphate is a flame retardant. After being illuminated, the electron motion orbit of nano molybdenum dioxide jumps to give off heat, thereby achieving ideal spectral heating effect. Meanwhile, in normal state, nano molybdenum dioxide is capable of emitting infrared rays, so that the infrared warmth preservation is achieved. Nano zinc oxide and nano cuprous oxide possess good antibacterial performance, and through the combination of them and the control of the dosing ratio, ideal antiviral performance against coronavirus and influenza is achieved. Due to the good flame retardancy of melamine phosphate, through adopting the coating and compounding method, the performances of melamine phosphate can be comprehensively used to prepare a multifunctional composite masterbatch with ideal spinnability.

The present invention also provides a preparation method of the multifunctional fiber with full-spectrum infrared radiation, flame retardant and antibacterial functions, comprising the steps of:
Step 1: processing modifiers: weighing raw materials and performing surface modification on modifiers;
Step 2: preparing a composite masterbatch: mechanically sequentially stirring an inorganic modifier and an organic modifier using a ball milling method, respectively coating the modifiers in a layered manner using polyethylene terephthalate, and dispersing the coated modifiers in the melt of polyethylene terephthalate or polycaprolactam, thereby obtaining the composite masterbatch;
Step 3: preparing a fiber: preparing a multifunctional fiber with full-spectrum infrared radiation, flame retardant and antibacterial functions by means of the spinning and texturing processes, wherein the inorganic modifiers include nano molybdenum dioxide, nano zinc oxide and nano cuprous oxide, and the organic modifier is melamine phosphate.

It is worth mentioning that, the inorganic modifiers and the organic modifiers are mechanically sequentially stirred by using a ball milling method, and PBT (polybutylene terephthalate) is used to be respectively coated on the inorganic modifiers in a layered manner. Namely, the inorganic modifiers are coated using a ball mill, wherein the powders of the inorganic modifiers are coated first, the powders of the inorganic modifiers with smaller average particle size are coated first, the powders of the organic modifiers are coated finally, and the powders of the organic modifiers are coated according to their thermal stability in sequence from high to low. The inorganic modifiers and organic modifiers are coated with PBT and uniformly dispersed in the melt of PET (polyethylene terephthalate) or PA6 (polycaprolactam). After the melting and mixing, the composite masterbatch is prepared.

Moreover, the spinning and texturing processes are optimized based on the prior art. Specifically, during the spinning and texturing process, the initial pressure of the spinning assembly is 80-100 kgf/cm², the spinning and false-twist texturing speed is 20-30% lower than that of the existing fabric, and the spinning temperature, false-twist texturing temperature and false-twist qualitative temperature are 15-20° C. lower than that of the existing fabric. The spinning process adopts a dual-path oiling, and the oiling rate is increased by 40%. The oiling rate during the false-twist texturing process is increased by 10%. The addition amount of the multifunctional composite masterbatch accounts for 10%-15% of the total amount of the fibers during the spinning process.

In another preferred embodiment, the average particle sizes of nano molybdenum dioxide, nano zinc oxide and nano cuprous oxide powders range from 100-400 nm.

In another preferred embodiment, in step 1, surface modification is performed on inorganic modifiers first, and specifically, dodecylbenzene sulfonic acid surfactant is used to modify the surface of nano-scale molybdenum dioxide by mechanically stirring in a ball mill, stearic acid complex ligand is used to modify the surfaces of nano zinc oxide and nano cuprous oxide, and ArC₃H₅ is used to modify the surface of melamine phosphate by using low-temperature plasma spraying method in a rotary plasma spraying machine.

In another preferred embodiment, in step 2, the coating temperature is 265-275° C., the coating duration is 30-50 minutes after each modifier is added into the ball mill.

In another preferred embodiment, the mass ratio of nano molybdenum dioxide, nano zinc oxide, nano cuprous oxide and melamine phosphate is 2:1:1:2.

### Advantages of the Invention

### Advantages

Compared with the prior art, the present invention has the following advantages:
1. Through adopting the aforesaid technical solution, nano molybdenum dioxide, nano zinc oxide, nano cuprous oxide and melamine phosphate are used as modifiers; first, dodecylbenzene sulfonic acid surfactant is used to modify the surface of nano molybdenum dioxide, and stearic acid complex ligand and ArC₃H₅ low-temperature plasma are used to modify the surfaces of nano zinc oxide and nano cuprous oxide such that their dispersibility can be significantly improved; subsequently, the modifiers are respectively coated by using PBT in several times in a layered manner through mechanically stirring using the ball milling method and are added into the masterbatch according to a certain proportion to prepare a multifunctional composite masterbatch with properties of photoheating, infrared warmth preservation, flame retardancy and anti-bacteria; after undergoing spinning and false-twist texturing processes including low temperature, low initial pressure, low drawing and dual-path oiling, a multifunctional fiber with properties of photoheating, infrared warmth preservation, flame retardancy and anti-bacteria is obtained;
2. The spinning and texturing processes are optimized such that the pressure of the spinning assembly, manufacturing speed, drawing ratio and heating temperature are reduced to ensure the stability of the coating structure in the spinning and false-twist texturing processes, thereby avoiding the interaction, reaction or agglomeration among different modifiers while ensuring that different modifiers do not interfere with each other; moreover, optimizing the spinning and texturing process also means reducing the breakage during the spinning process and improving the spinnability while ensuring that the use requirements are met;
3. Compared with conventional fabrics, after being illuminated for 5-10 minutes, the temperature difference of the fiber fabric of the present invention is higher than 15-20° C., the far-infrared emissivity is greater than 98%, the radiation temperature rise is greater than 3.0° C., the CLO value is greater than 0.5, the heat transfer coefficient is greater than 18.0 w/(m² k), and the thermal resistance is less than 0.05 (m² k)/w; the antibacterial rate against Escherichia coli, Staphylococcus aureus, Candida albicans and pneumobacillus is greater than 99.0%; the present invention also achieves good antiviral effect against influenza and coronavirus; the antiviral activity value is greater than 2.5, the antiviral activity rate is greater than 99.5%, the limit oxygen index is greater than 35%, the smoldering duration and after-flame duration are 0, and the damage length is 90-100 cm;
4. Through adopting the present invention, the production process of the existing equipment is optimized, which allows the fiber to be produced without equipment upgrading such that the application range of polyester and nylon is significantly widened; the present invention optimizes the spinning and texturing processes, improves the lightweight and protective performances of clothing fabrics, and achieves remarkable economic and social benefits.

### THE PREFERRED EMBODIMENTS

### Preferred Embodiments of the Invention

While specific embodiments of the invention have been described in detail, it will be appreciated by those skilled in the art that various modifications and alternatives to those details could be developed in light of the overall teachings of the present invention. Accordingly, the particular arrangements disclosed are meant to be illustrative only and not limiting as to the scope of the invention which is to be given the full breadth of the claims appended and any and all equivalents thereof.

Unless otherwise specified, the experimental methods or test methods described in the following embodiments are conventional methods, and the reagents and materials are obtained from conventional commercial ways or prepared by using conventional methods.

### Embodiment 1

The present invention provides a multifunctional fiber with full-spectrum infrared radiation, flame retardant and antibacterial functions, comprising: a composite masterbatch having a water content of 30-50 ppm and accounting for 10-12% by weight, polyethylene terephthalate having a water content of 25-30 ppm or polycaprolactam high polymer having a water content of 50-70 ppm and accounting for 88-90% by weight. The composite masterbatch further comprising: polyethylene terephthalate having a water content of 23-27 ppm and accounting for 40-50% by weight, nano molybdenum oxide accounting for 6.7-10.0% by weight, nano zinc oxide accounting for 3.3-5.0% by weight, nano cuprous oxide accounting for 3.3-5.0% by weight, and melamine phosphate having a water content of 25-30 ppm and accounting for 6.7-10.0% by weight.

The preparation method of the multifunctional fiber of the present invention comprising the steps of:
Step 1: processing modifiers: weighing raw materials and performing surface modification on modifiers; specifically, dodecylbenzene sulfonic acid surfactant is used to modify the surface of nano molybdenum dioxide by mechanically stirring in a ball mill, stearic acid complex ligand is used to modify the surfaces of nano zinc oxide and nano cuprous oxide, and ArC₃H₅ is used to modify the surface of melamine phosphate by using low-temperature plasma spraying method in a rotary plasma spraying machine
Step 2: preparing a composite masterbatch: mechanically sequentially stirring an inorganic modifier and an organic modifier using a ball milling method, respectively coating the modifiers in a layered manner using polybutylene terephthalate, and dispersing the coated modifiers in the melt of polyethylene terephthalate or polycaprolactam, thereby obtaining the composite masterbatch;

Step 3: preparing a fiber: preparing a multifunctional fiber with full-spectrum infrared radiation, flame retardant and antibacterial functions by means of the spinning and texturing processes, wherein the inorganic modifiers include nano molybdenum dioxide, nano zinc oxide and nano cuprous oxide, and the organic modifier is melamine phosphate, wherein in step 2, the coating temperature is 265-275° C., the coating duration is 30-50 minutes after each modifier is added into the ball mill.

### Embodiment 2

In this embodiment, nano molybdenum dioxide, nano zinc oxide, nano cuprous oxide and melamine phosphate are used as modifiers. The average particle sizes of nano molybdenum dioxide, nano zinc oxide and nano cuprous oxide powders are controlled at 200 nm, 100 nm and 100 nm. First, after mechanically stirring by using a ball milling method, dodecylbenzene sulfonic acid surfactant is used to modify the surface of nano molybdenum dioxide in a vacuum high-temperature vibrating ball mill, and stearic acid complex ligand is used to modify the surfaces of nano zinc oxide and nano cuprous oxide. Subsequently, ArC₃H₅ is used to modify the surface of melamine phosphate by using low-temperature plasma spraying method in a rotary plasma spraying machine. PBT coating and compounding are performed in several times by mechanically stirring by using the ball milling method. According to 40% of the total amount of the prepared composite masterbatch, PBT chips are added into the vacuum high-temperature vibrating ball mill, and the temperature is raised to 265° C. in a stirring state. When PBT is completely melted, nano zinc oxide powder is added into PBT according to 3.3% of the total amount of the prepared composite masterbatch and is ball-milled at a high temperature. After mechanically stirring for 40 minutes, nano cuprous oxide powder is added according to 3.3% of the total amount of the composite masterbatch and is ball-milled at a high temperature. After mechanically stirring for 30 minutes, nano molybdenum dioxide is added according to 6.7% of the total amount of the composite masterbatch. After being ball-milled for 30 minutes, melamine phosphate is added according to 6.7% of the total amount of the composite masterbatch. After being ball-milled for 30 minutes, PA6 chips are added according to 40% of the total amount of the composite masterbatch. After being ball-milled and stirred for 30 minutes, the multifunctional composite masterbatch with 20% active ingredients is obtained after stretching, banding, water cooling and grain-sized dicing.

On a conventional spinning device, PA6 chips are used as raw materials. After PA6 chips are melted, 15% multifunctional masterbatch is added into PA6 for blend-spinning, wherein the spinning temperature is 250° C. and the spinning speed is 3800 m/min. After the blend-spinning, 52 dtex/24f nylon 6 flame-retardant antibacterial fiber POY is obtained, and after being processed and texturized by using a Barmag EFK-1000V false-twist texturing machine, 44 dtex/24f nylon 6 multifunctional fiber with full-spectrum infrared radiation, flame retardant and antibacterial functions DTY is obtained. Compared with conventional 44 dtex/24f nylon 6 fiber fabric, after being illuminated for 5 minutes, the temperature difference of the fiber fabric of the present invention is higher than 16° C. After being illuminated for 10 minutes, the temperature difference of the fiber fabric of the present invention is higher than 18° C. The far-infrared emissivity is greater than 98.3%, the radiation temperature rise is greater than 3.2° C., the CLO value is greater than 0.53, the heat transfer coefficient is greater than 18.6 w/(m² k), and the thermal resistance is less than 0.048 (m² k)/w. The antibacterial rate against Escherichia coli and Staphylococcus aureus is 99.6%. The antibacterial rate against Candida albicans is 99.3%, and the antibacterial rate against pneumobacillus is 99.1%. The present invention also achieves good antiviral effect against influenza and coronavirus. The antiviral activity value is greater than 2.5, the antiviral activity rate is greater than 99.5%, the limit oxygen index is greater than 35.1%, the smoldering duration and after-flame duration are 0, and the damage length is 93 cm.

### Embodiment 3

In this embodiment, nano molybdenum dioxide, nano zinc oxide, nano cuprous oxide and melamine phosphate are used as modifiers. The average particle sizes of nano molybdenum dioxide, nano zinc oxide and nano cuprous oxide powders are controlled at 100 nm, 200 nm and 400 nm. First, after mechanically stirring by using a ball milling method, dodecylbenzene sulfonic acid surfactant is used to modify the surface of nano molybdenum dioxide in a vacuum high-temperature vibrating ball mill, and stearic acid complex ligand is used to modify the surfaces of nano zinc oxide and nano cuprous oxide. Subsequently, ArC₃H₅ is used to modify the surface of melamine phosphate by using low-temperature plasma spraying method in a rotary plasma spraying machine. PBT coating and compounding are performed in several times by mechanically stirring by using the ball milling method. According to 50% of the total amount of the prepared composite masterbatch, PBT chips are added into the vacuum high-temperature vibrating ball mill, and the temperature is raised to 275° C. in a stirring state. When PBT is completely melted, nano molybdenum dioxide powder is added into PBT according to 10.0% of the total amount of the prepared composite masterbatch and is ball-milled at a high temperature. After mechanically stirring for 50 minutes, nano zinc oxide powder is added according to 5.0% of the total amount of the composite masterbatch and is ball-milled at a high temperature. After mechanically stirring for 40 minutes, nano cuprous oxide is added according to 5.0% of the total amount of the composite masterbatch. After being ball-milled for 40 minutes, melamine phosphate is added according to 10.0% of the total amount of the composite masterbatch. After being ball-milled for 32 minutes, PA6 chips are added according to 20% of the total amount of the composite masterbatch. After being ball-milled and stirred for 30 minutes, the multifunctional composite masterbatch with 30% active ingredients is obtained after stretching, banding, water cooling and grain-sized dicing.

On a conventional spinning device, PA6 chips are used as raw materials. After PA6 chips are melted, 10% multifunctional masterbatch is added into PA6 for blend-spinning, wherein the spinning temperature is 250° C. and the spinning speed is 3800 m/min. After the blend-spinning, 52 dtex/24f nylon 6 flame-retardant antibacterial fiber POY is obtained, and after being processed and texturized by using a Barmag EFK-1000V false-twist texturing machine, 44 dtex/24f nylon 6 multifunctional fiber with full-spectrum infrared radiation, flame retardant and antibacterial functions DTY is obtained. Compared with conventional 44 dtex/24f nylon 6 fiber fabric, after being illuminated for 5 minutes, the temperature difference of the fiber fabric of the present invention is higher than 17° C. After being illuminated for 10 minutes, the temperature difference of the fiber fabric of the present invention is higher than 20° C. The far-infrared emissivity is greater than 99.0%, the radiation temperature rise is greater than 3.5° C., the CLO value is greater than 0.56, the heat transfer coefficient is greater than 19.8 w/(m² k), and the thermal resistance is less than 0.036 (m² k)/w. The antibacterial rate against Escherichia coli and Staphylococcus aureus is 99.9%. The antibacterial rate against Candida albicans is 99.6%, and the antibacterial rate against pneumobacillus is 99.5%. The present invention also achieves good antiviral effect against influenza and coronavirus. The antiviral activity value is greater than 3.6, the antiviral activity rate is greater than 99.8%, the limit oxygen index is greater than 37.8%, the smoldering duration and after-flame duration are 0, and the damage length is 90 cm.

### Embodiment 4

In this embodiment, nano molybdenum dioxide, nano zinc oxide, nano cuprous oxide and melamine phosphate are used as modifiers. The average particle sizes of nano molybdenum dioxide, nano zinc oxide and nano cuprous oxide powders are controlled at 100 nm, 300 nm and 200 nm. First, after mechanically stirring by using a ball milling method, dodecylbenzene sulfonic acid surfactant is used to modify the surface of nano molybdenum dioxide in a vacuum high-temperature vibrating ball mill, and stearic acid complex ligand is used to modify the surfaces of nano zinc oxide and nano copper oxide. ArC₃H₅ is used to modify the surface of melamine phosphate by using low-temperature plasma spraying method in a rotary plasma spraying machine. PBT coating and compounding are performed in several times by mechanically stirring by using the ball milling method. According to 45% of the total amount of the prepared composite masterbatch, PBT chips are added into the vacuum high-temperature vibrating ball mill, and the temperature is raised to 269° C. in a stirring state. When PBT is completely melted, nano molybdenum dioxide powder is added into PBT according to 8.0% of the total amount of the prepared composite masterbatch and is ball-milled at a high temperature. After mechanically stirring for 36 minutes, nano cuprous oxide powder is added according to 4.0% of the total amount of the composite masterbatch and is ball-milled at a high temperature. After mechanically stirring for 33 minutes, nano zinc oxide is added according to 4.0% of the total amount of the composite masterbatch. After being ball-milled for 39 minutes, melamine phosphate is added according to 8.0% of the total amount of the composite masterbatch. After being ball-milled for 33 minutes, PET chips are added according to 31% of the total amount of the composite masterbatch. After being ball-milled and stirred for 37 minutes, the multifunctional composite masterbatch with 24% active ingredients is obtained after stretching, banding, water cooling and grain-sized dicing.

On a conventional spinning device, PETchips are used as raw materials. After PET chips are melted, 13% multifunctional masterbatch is added into PET for blend-spinning, wherein the spinning temperature is 275° C. and the spinning speed is 2500 m/min. After the blend-spinning, 265 dtex/48f polyester fiber POY with full-spectrum infrared radiation, flame retardant and antibacterial functions is obtained, and after being processed and texturized by using a Barmag EFK-1000V false-twist texturing machine, 167 dtex/48f polyester multifunctional fiber DTY with full-spectrum infrared radiation, flame retardant and antibacterial functions is obtained. Compared with conventional 167 dtex/48f polyester fiber fabric, after being illuminated for 5 minutes, the temperature difference of the fiber fabric of the present invention is higher than 18° C. After being illuminated for 10 minutes, the temperature difference of the fiber fabric of the present invention is higher than 20° C. The far-infrared emissivity is greater than 99.0%, the radiation temperature rise is greater than 3.5° C., the CLO value is greater than 0.55, the heat transfer coefficient is greater than 18.9 w/(m² k), and the thermal resistance is less than 0.037 (m² k)/w. The antibacterial rate against Escherichia coli and Staphylococcus aureus is 99.8%. The antibacterial rate against Candida albicans is 99.5%, and the antibacterial rate against pneumobacillus is 99.4%. The present invention also achieves good antiviral effect against influenza and coronavirus. The antiviral activity value is greater than 3.9, the antiviral activity rate is greater than 99.7%, the limit oxygen index is greater than 35.7%, the smoldering duration and after-flame duration are 0, and the damage length is 91 cm.

### Embodiment 5

In this embodiment, nano molybdenum dioxide, nano zinc oxide, nano cuprous oxide and melamine phosphate are used as modifiers. The average particle sizes of nano molybdenum dioxide, nano zinc oxide and nano cuprous oxide powders are controlled at 150 nm, 200 nm and 270 nm. First, after mechanically stirring by using a ball milling method, dodecylbenzene sulfonic acid surfactant is used to modify the surface of nano molybdenum dioxide in a vacuum high-temperature vibrating ball mill, and stearic acid complex ligand is used to modify the surfaces of nano zinc oxide and nano copper oxide. ArC₃H₅ is used to modify the surface of melamine phosphate by using low-temperature plasma spraying method in a rotary plasma spraying machine. PBT coating and compounding are performed in several times by mechanically stirring by using the ball milling method. According to 28% of the total amount of the prepared composite masterbatch, PBT chips are added into the vacuum high-temperature vibrating ball mill, and the temperature is raised to 272° C. in a stirring state. When PBT is completely melted, nano molybdenum dioxide powder is added into PBT according to 9.0% of the total amount of the prepared composite masterbatch and is ball-milled at a high temperature. After mechanically stirring for 40 minutes, nano zinc oxide powder is added according to 4.5% of the total amount of the composite masterbatch and is ball-milled at a high temperature. After mechanically stirring for 30 minutes, nano cuprous oxide is added according to 4.5% of the total amount of the composite masterbatch. After being ball-milled for 34 minutes, melamine phosphate is added according to 9.0% of the total amount of the composite masterbatch. After being ball-milled for 36 minutes, PET chips are added according to 28% of the total amount of the composite masterbatch. After being ball-milled and stirred for 38 minutes, the multifunctional composite masterbatch with 27% active ingredients is obtained after stretching, banding, water cooling and grain-sized dicing.

On a conventional spinning device, PET chips are used as raw materials. After PET chips are melted, 12% multifunctional masterbatch is added into PET for blend-spinning, wherein the spinning temperature is 280° C. and the spinning speed is 2700 m/min. After the blend-spinning, 125 dtex/72f polyester fiber POY with full-spectrum infrared radiation, flame retardant and antibacterial functions is obtained, and after being processed and texturized by using a Barmag EFK-1000V false-twist texturing machine, 83 dtex/72f polyester multifunctional fiber DTY with full-spectrum infrared radiation, flame retardant and antibacterial functions is obtained. Compared with conventional 83 dtex/72f polyester fiber fabric, after being illuminated for 5 minutes, the temperature difference of the fiber fabric of the present invention is higher than 16° C. After being illuminated for 10 minutes, the temperature difference of the fiber fabric of the present invention is higher than 19° C. The far-infrared emissivity is greater than 98.6%, the radiation temperature rise is greater than 3.3° C., the CLO value is greater than 0.55, the heat transfer coefficient is greater than 18.9 w/(m² k), and the thermal resistance is less than 0.042 (m² k)/w. The antibacterial rate against Escherichia coli and Staphylococcus aureus is 99.9%. The antibacterial rate against Candida albicans is 99.5%, and the antibacterial rate against pneumobacillus is 99.3%. The present invention also achieves good antiviral effect against influenza and coronavirus. The antiviral activity value is greater than 2.9, the antiviral activity rate is greater than 99.4%, the limit oxygen index is greater than 36.8%, the smoldering duration and after-flame duration are 0, and the damage length is 96 cm.

In conclusion, according to the multifunctional fiber with full-spectrum infrared radiation, flame retardant and antibacterial functions and the preparation method thereof, the fiber and its fabric possess multiple functions such as spectral heating, flame retardancy, anti-bacteria and anti-virus. Compared with conventional fabrics, after being illuminated for 5-10 minutes, the temperature difference of the fabric of the present invention is higher than 15-20° C., the far-infrared emissivity is greater than 98%, the radiation temperature rise is greater than 3.0° C., the CLO value is greater than 0.5, the heat transfer coefficient is greater than 18.0 w/(m² k), and the thermal resistance is less than 0.05 (m² k)/w; the antibacterial rate against Escherichia coli, Staphylococcus aureus, Candida albicans and pneumobacillus is greater than 99.0%; the present invention also achieves good antiviral effect against influenza and coronavirus; the antiviral activity value is greater than 2.5, the antiviral activity rate is greater than 99.5%, the limit oxygen index is greater than 35%, the smoldering duration and after-flame duration are 0, and the damage length is 90-100 cm. Therefore, a wide application range is achieved.

The above are merely preferred embodiments of the present invention. Therefore, equivalent changes or modifications made within the spirit and principle of the present invention shall fall into the scope defined by the claims of the present invention.

1. A multifunctional fiber with full-spectrum infrared radiation, flame retardant and antibacterial functions, comprising: a composite masterbatch having a water content of 30-50 ppm and accounting for 10-12% by weight, polyethylene terephthalate having a water content of 25-30 ppm or polycaprolactam high polymer having a water content of 50-70 ppm and accounting for 88-90% by weight.

2. The multifunctional fiber with full-spectrum infrared radiation, flame retardant and antibacterial functions of claim 1, wherein the composite masterbatch further comprising:
polybutylene terephthalate having a water content of 23-27 ppm and accounting for 40-50% by weight, nano molybdenum oxide accounting for 6.7-10.0% by weight, nano zinc oxide accounting for 3.3-5.0% by weight, nano cuprous oxide accounting for 3.3-5.0% by weight, and melamine phosphate having a water content of 25-30 ppm and accounting for 6.7-10.0% by weight.

3. A preparation method of the multifunctional fiber with full-spectrum infrared radiation, flame retardant and antibacterial functions, comprising the steps of:
step 1: processing modifiers: weighing raw materials and performing surface modification on modifiers;
step 2: preparing a composite masterbatch: mechanically and sequentially stirring an inorganic modifier and an organic modifier using a ball milling method, respectively coating the modifiers in a layered manner using polybutylene terephthalate, and dispersing the coated modifiers in a melt of polyethylene terephthalate or polycaprolactam, thereby obtaining the composite masterbatch;
step 3: preparing a fiber: preparing a multifunctional fiber with full-spectrum infrared radiation, flame retardant and antibacterial functions by means of spinning and texturing processes, wherein the inorganic modifiers comprising nano molybdenum dioxide, nano zinc oxide and nano cuprous oxide, and the organic modifier is melamine phosphate.

4. The preparation method of the multifunctional fiber with full-spectrum infrared radiation, flame retardant and antibacterial functions of claim 3, wherein average particle sizes of nano molybdenum dioxide, nano zinc oxide and nano cuprous oxide powders range from 100-400 nm.

5. The preparation method of the multifunctional fiber with full-spectrum infrared radiation, flame retardant and antibacterial functions of claim 3, wherein in step 1, surface modification is performed on inorganic modifiers first, and wherein dodecylbenzene sulfonic acid surfactant is used to modify the surface of nano-scale molybdenum dioxide by mechanically stirring in a ball mill, wherein stearic acid complex ligand is used to modify the surfaces of nano zinc oxide and nano cuprous oxide, and wherein ArC₃H₅ is used to modify the surface of melamine phosphate by using low-temperature plasma spraying method in a rotary plasma spraying machine.

6. The preparation method of the multifunctional fiber with full-spectrum infrared radiation, flame retardant and antibacterial functions of claim 3, wherein in step 2, the coating temperature is 265-275° C., and the coating duration is 30-50 minutes after each modifier is added into the ball mill.

7. The preparation method of the multifunctional fiber with full-spectrum infrared radiation, flame retardant and antibacterial functions of claim 3, wherein mass ratio of nano molybdenum dioxide, nano zinc oxide, nano cuprous oxide and melamine phosphate is 2:1:1:2.
